(19) United States
(12) Patent Application Publication
(10) Pub. No.: US 2008/0140398 A1
(43) Pub. Date: Jun. 12, 2008

(54) System and a Method For Representing Unrecognized Words in Speech to Text Conversions as Syllables

(76) Inventor: Avraham Shpigel, Rishon Lezion (IL)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 11/722,730

(22) PCT Filed: Dec. 29, 2005
(86) PCT No.: PCT/IL05/01401

§ 371 Date: Jun. 25, 2007

Related U.S. Application Data
(60) Provisional application No. 60/639,778, filed on Dec. 29, 2004.
(60) Provisional application No. 60/663,253, filed on Mar. 21, 2005.
(60) Provisional application No. 60/698,977, filed on Jul. 14, 2005.

(51) Int. Cl. G10L 15/22

(52) U.S. Cl. 704/235; 704/E15.04

(57) ABSTRACT

The present invention is a novel system and method for overcoming the shortcomings of existing speech-to-text systems which relates to the processing of unrecognized words. On encountering words which are not decipherable by it the preferred embodiment of the present invention analyzes the syllables which make up these words and translates them into the appropriate phonetic representations. The method described by the present invention ensures that words which were not uttered clearly would not be lost or distorted in the process of transcribing the text. Additionally, it allows using smaller and simpler speech-to-text applications, which are suitable for mobile devices with limited storage and processing resources, since these applications may use smaller dictionaries and may be designed only to identify commonly used words. Also disclosed are several examples for possible implementations of the described system and method.

### FIELD OF THE INVENTION

The present invention relates to the automatic process of speech recognition, and, in particular, to a method for conversion of speech to readable text combining full identified words with words represented by combinations of syllables.

### BACKGROUND OF THE INVENTION

Automatic speech-to-text conversion is already applied in areas such as Interactive Voice Response (IVR) systems, dictation apparatuses, and for the training of or the communication with the hearing impaired. The replacement of live speech with written text is considerably cost effective in communication media where the reduction of time required for delivery of transmission and the price of transmission required thereof is significantly reduced. Additionally, speech-to-text conversion is also beneficial in interpersonal communication since reading written text can be ten times faster than speech of the same.

Like many implementations of signal processing, speech recognition of all varieties are prone to difficulties such as noise and distortion of signals which leads to the need of complex and cumbersome software and electrical circuitry in order to optimize the conversion of audio into known words. The present invention enables overcoming the drawbacks of prior art methods and more importantly, by raising the compression factor of the human speech, it enables the reduction of transmission time needed for conversation and thus reduces risks involving exposure to cellular radiation and considerably reduces communication resources and cost. The present invention is suitable for various chat applications and for the delivery of messages, where the speech-to-text output is read by a human user, and not processed automatically, since humans have heuristic abilities which would enable them to decipher information which would otherwise be lost. It may be also used for applications such as dictation, involving manual corrections when needed.

In recent years there have been numerous implementations of speech-to-text algorithms in various methods and systems. Due to the nature of audio input, the ability to handle unidentified words is crucial for the efficacy of such systems. Two methods for dealing with unrecognized words according to prior art include asking the speaker to repeat the unrecognized utterances or finding a word which may be considered as the closest, even if it is not the exact word. However, while the first method is time consuming and may be applied only when the speech-to-text conversion is performed in real-time, the second method may yield unexpected results which may alter the meaning of the given sentences.

U.S. Pat. No. 6,785,650 describes a method for hierarchical transcription and displaying of input speech. The disclosed method includes the ability to combine representation of high confidence recognized words with words constructed by a combination of known syllables and of phones. There is no construction of unknown words by the use of vowels anchors identification and search of adjacent consonants to complete the syllables.

Moreover, U.S. Pat. No. 6,785,650 suggests combining known syllables with phones of unrecognized syllables in the same word whereas the present invention replaces the entire unknown word by syllables leaving their interpretation to the user. By displaying partially-recognized words the method described by U.S. Pat. No. 6,785,650 obstructs the process of deciphering the text by the user since word segments are represented as complete words and are therefore spelled according to word-spelling rules and not according to syllable spelling rules. There is therefore a need for a means for transcribing and representing unidentified words in a speech-to-text conversion algorithm in syllables.

### SUMMARY OF THE INVENTION

The present invention discloses a method for converting audible input into text. The method includes the steps of applying speech-to-text recognition techniques for identifying words of received audible input; verifying identified words against vocabulary database of words; and identifying syllable of unidentified audible input or utterances; creating a combined text of the recognized words appearing in the vocabulary database and the sequences of the identified syllables of the words not found in the vocabulary database. The method of identifying the syllables includes the steps of identifying vowels of the analyzed word, identifying the consonants appearing before each vowel and associating them to said vowel, identifying the consonants appearing after each vowel which were not already associated with the next vowel and associating them with their preceding vowel, and creating phonetic sequences of letters based on all identified syllables.

The audible input is originated by a first user for communicating with a second user by relaying combined text to the second user and presenting the second user the combined text. The combined text may be presented to the first user before relaying it to the second user, the first user may then edit the combined text before relaying it to the second user. The first and second users may communicate through a wireless communication network. The combined text is transferred from the mobile phone of the first user to the mobile phone of the second user through a wireless communication network. Alternatively, the first and second users may be participants of a wireless communication session. In such cases the combined text is transferred from the mobile phone of the first user to the mobile phone of the second user through the open connection of the wireless communication session. According to an additional embodiment the first and second users may communicate through a wired communication network. The combined text is then transferred from the terminal of the first user to a terminal of the second user through the wired communication network.

The audible input may originate from a user requesting service from a call center. The call center may then include a software application which analyzes the combined message text in accordance with its context and performing a service action in accordance with said message analysis, The action may include a predefined response to be sent to the user. Alternatively, the service action may include an identification of required service and selection of appropriate customer service representative to take care of the required service, the customer service representative is then provided with the combined text. According to an additional embodiment the audible input is originated by a user requesting service from a call center and the combined message text is transferred to at least one customer service representative. The customer service representative selects the appropriate action in accordance with the received combined text.

According to an additional embodiment of the present invention the audible input is originated by a user requesting to create a communication session with a second user. The combined message text is relayed to at least one telephone switcher associated with said second user. The second user is enabled to read the combined text and select the appropriate action.

The method includes the ability to change the text formats of said syllables of unidentified audible input or utterances within the combined text and filtering out unidentified audible input or utterances which are recognized as background noise. The combined text may be saved as backup file for audio inputs. The combined text may also be utilized as a text for dictating purposes.

### BRIEF DESCRIPTION OF THEE DRAWINGS

These and further features and advantages of the invention will become more clearly understood in the light of the ensuing description of a preferred embodiment thereof, given by way of example, with reference to the accompanying drawings, wherein

FIG. 1 is a flowchart illustrating the operation of the speech-to-text procedure according to a preferred embodiment of the present invention;

FIG. 2 is a flowchart illustrating an vowel-based algorithm for identifying syllables according to a preferred embodiment of the present invention;

FIG. 3 is an illustration of the environment of the first embodiment of the present invention;

FIG. 4 is an illustration of the proposed procedure as it is implemented in a call center according to a third embodiment of the present invention.

### DETAILED DESCRIPTION OF THE PREFERRED EMBODIMENTS

The present invention is a novel system and method for overcoming the shortcomings of existing speech-to-text systems which relates to the processing of unrecognized words. On encountering words which are not decipherable by it the preferred embodiment of the present invention analyzes the syllables which make up these words and translates them into the appropriate phonetic representations. The method described by the present invention ensures that words which were not uttered clearly would not be lost or distorted in the process of transcribing the text. Additionally, it allows using smaller and simpler speech-to-text applications, which are suitable for mobile devices with limited storage and processing resources, since these applications may use smaller dictionaries and may be designed only to identify commonly used words. Also disclosed are several examples for possible implementations of the described system and method.

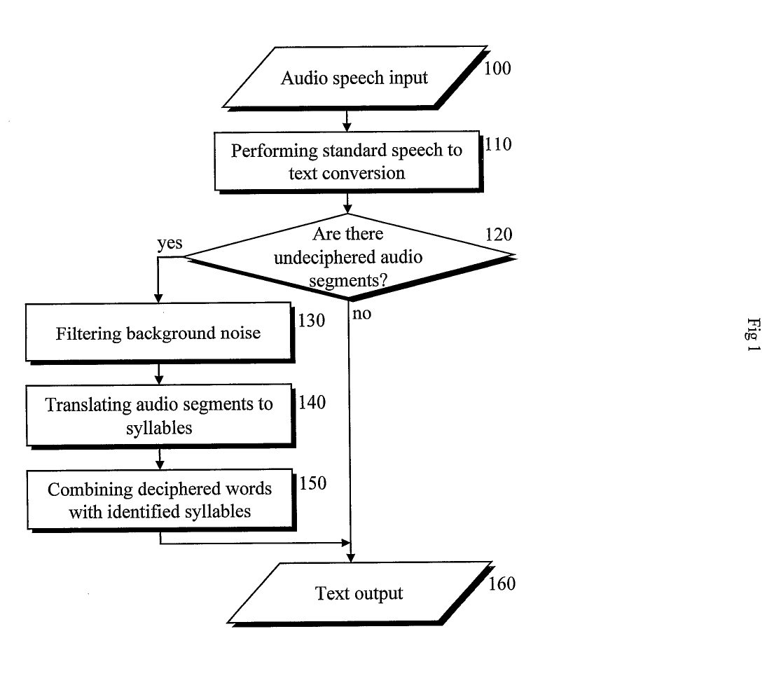

FIG. 1 is a flowchart illustrating the operation of speech-to-text algorithm in accordance with the preferred embodiment of the present invention. The audio input 100 is first processed by standard speech-to-text conversion procedure 110, as is known in the art. Having completed, the algorithm identifies whether any segments of the audio input flow 100 were not deciphered by the speech-to-text conversion procedure 110. These segments may include a single word or several consecutive words which were not identified by the speech-to-text conversion procedure 110, non-verbal utterances or background noise. The background noise is filtered out 130. The unidentified words may include words which were not pronounced accurately, non-standard names, slang, abbreviations or words in languages which cannot be recognized by standard speech-to-text procedures. The non-verbal utterances may include any type of interjection pronounced by the speaker to express various emotions such as surprise, laughter, delight, disgust, or pain. Next, the undeciphered segments of the audio flow are transcribed into syllables 140; the procedure for performing the transcription is described below. Finally, by combining the identified words with the syllables in their correct order of appearance 150 a single text is produced 160.

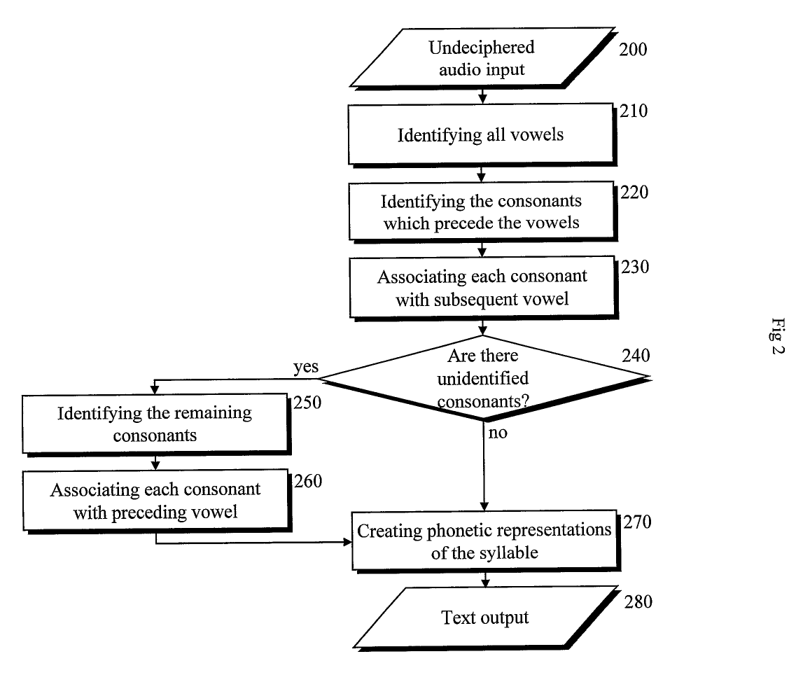

FIG. 2 is a flowchart illustrating a method for transcribing the unidentified segments of the audio flow into syllables according to one embodiment of the present invention. The illustrated method uses vowels as anchors. The undeciphered segments of the audio flow 200 are processed. First, all vowels are identified 210, then the consonant which precedes the vowel is identified 220 and associated with the vowel 230. Provided that there are still consonants which were not identified and associated with a vowel 240 they are identified 250 and associated with their preceding vowel 260. For instance, if the unidentified word is “basket” the vowels “a” and “e” are identified at the first step, then the consonant “b” is identified and associated with the first vowel “a” and “k” is identified and associated with the second vowel “e” and then the “s” is identified and associated with the preceding vowel “a” and “t” is identified and associated with the “e”. The final outcome is therefore comprised of two syllables: “bas” and “ket”. In the final steps the identified syllables are given phonetic representation 270 and the output text of the audio segment is composed 280. It is important to note that since spelling rules cannot be applied for all syllables, the spelling of the final transcript is phonetic and may include erroneous spelling, such as “bak” for the word “back”. The construction methods and identification examples mentioned herein are for the purpose of demonstration solely and by no means limit the implementation of the present invention.

Since it is reasonable to assumed that in order to understand the syllables text the user may require additional heuristic skills that are not needed for reading known words, the syllables in the resulting text may be displayed differently than the identified words. The syllables may be displayed in uppercase letters, using a different font or a different font style (e.g. bold, italic or underlined). Additionally, the syllables may be separated by a single space, a hyphen, a middle dot or any other graphic means. If, for example the unidentified words are “big basket”, they are transcribed into three syllables: “big”, “bas” and “ket”. In their textual representation they may therefore appear as BIG BAS KET, BIG-BAS-KET, BIG-BAS-KET or BIG•BAS•KET.

If the text in question is in a language which does not have a simple and highly accessible means for representing syllables, such as Semite languages (e.g. Arabic and Hebrew), the syllables may be presented in Latin letters. In such cases the Latin syllable letters are combined with the known words in the original language to insure the comprehension of the text by the reader.

According to the first embodiment the above mentioned algorithm is used to transcribe audio messages to text messages in cellular communication. Adding speech-to-text functionality enables users to vocally record short announcements and send them as standard messages in short messaging system (SMS) format. Since most cellular devices do not have full keyboards and allow users to write text messages using only the keypad, the procedure of composing text messages is cumbersome and time-consuming. Speech-to-text functionality enables offering users of cellular devices a much easier and faster manner for composing text messages. However, most speech-to-text applications are not particularly useful for SMS communication since SMS users tend to use many abbreviations, acronyms, slang and neologisms which are in no way standard and are therefore not part of commonly used speech-to-text libraries. The functionality disclosed by the present invention overcomes this problem by providing the user with a phonetic representation of unidentified words. Thus, non-standard words may be used and are not lost in the transference from spoken language to the text.

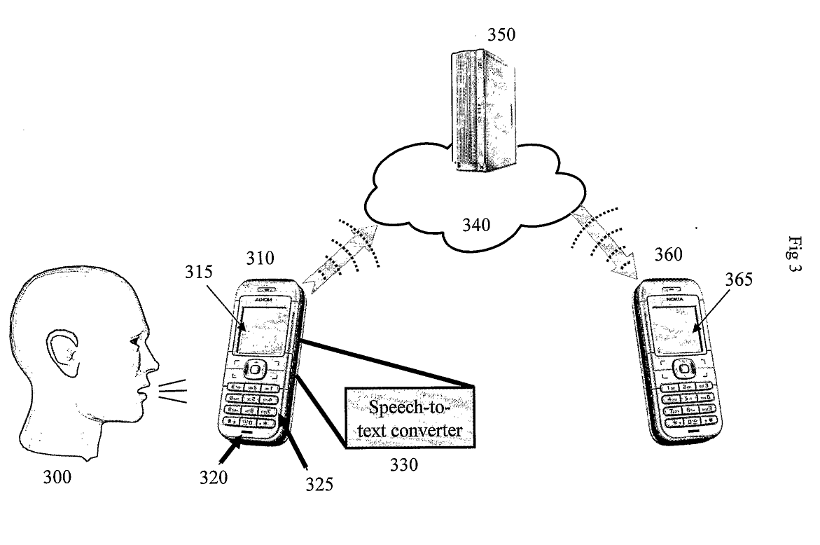

The implementation of the above mentioned algorithm in cellular communication according to the first embodiment of the present invention is illustrated in FIG. 3. The algorithm operates within a speech-to-text converter 330, which is integrated into cellular device 310. To make use of the functionality offered by the speech-to-text converter 330, user 300 pronounces a short message which is captured by microphone 320 of cellular device 310. The Speech-to-text converter 330 transcribes the audio message into text according to the algorithm described above. The transcribed message is then presented to the user on display 315. Optionally, the user may edit the message using keypad 325 and when satisfied user 300 sends the message using conventional SMS means to a second device 360. The message is sent to SMS server 350 on cellular network 340 via cellular communication and routed to second device 360. When retrieved, the message appears on display 365 of second device 360 in textual format. The message may also be converted back into speech by second device 360 using standard text-to-speech converters. Second device 360 may be any type of cellular device which can receive SMS messages, a public switch telephone network (PSTN) device which can display SMS messages or represent them to the user in any other means or an internet application.

According to a second embodiment of the present invention cellular device 310 and second device 360 may establish a text communication session. In the text communication session the information is transformed into text format before being sent to the other party. This means of communication is especially advantageous in narrow-band communication protocols and in communication protocols which make use of Code Division Multiple Access (CDMA) communication means. Since in CDMA the cost of the call is determined according to the volume of transmitted data, the major reduction of data volume which the conversion of audio data to textual data enables dramatically reducing the overall cost of the call. For the purpose of implementing this embodiment the speech-to-text converter 330 is inside each of the devices 310, 360. The spoken words of each user of the text communication session is automatically transcribed according to the above-described transcription algorithm and transmitted to the other party.

Additional embodiments may include the implementation of the proposed speech-to-text algorithm in instant messaging applications, emails and chats. Integrating the speech-to-text conversion according to the disclosed algorithm into such application would allow users to enjoy a highly communicable interface to text-based applications. In all of the above mentioned embodiments the speech-to-text conversion component may be implemented in the end device of the user or in any other point in the network, such as on the server, the gateway and the like.

According to a third embodiment of the present invention the disclosed speech-to-text algorithm is integrated into Interactive Voice Response (IVR) systems. IVR systems provide the technological framework of call centers which combine voice-activated directories and customer service representatives. In such systems the user may be asked to verbally state the purpose of the call or verbally select options from a menu. The proposed embodiment may be implemented in semiautomatic IVR systems or in fully manual systems. In semiautomatic IVR systems the user may activate some of the menu options and commands without needing the help of a customer service representative, whereas in fully manual systems all the activities of the user are controlled by a customer service representative. The proposed method may be implemented in the semiautomatic and in the fully manual systems whenever the verbal response of the user is analyzed by a customer service representative, the disclosed syllable-based speech-to-text algorithm may be used to textually represent to the customer service representative the content of the words of the user. The customer service representative may then manually handle the call of the user appropriately.

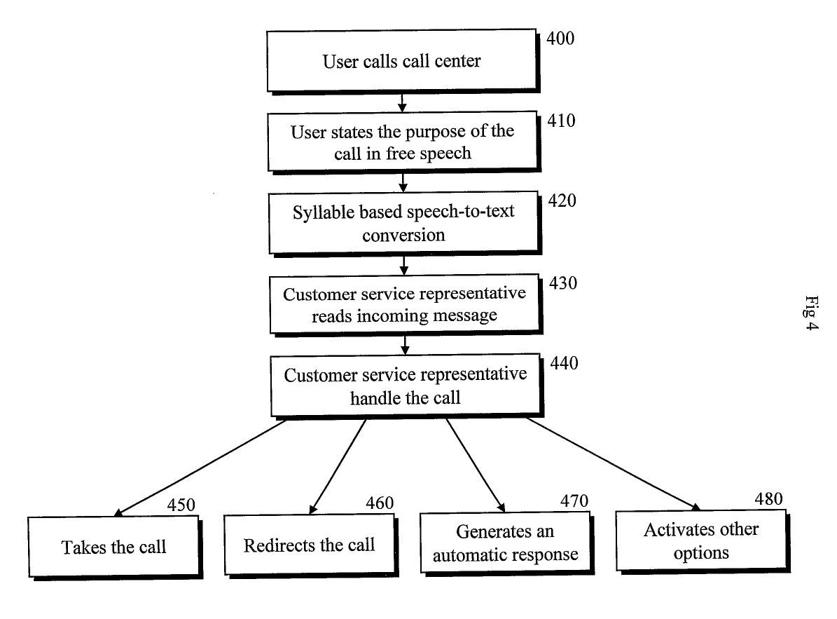

An additional implementation of the proposed speech-to-text algorithm in call centers is illustrated in FIG. 4. This embodiment includes a fully or a semi manual procedure. According to this embodiment the user calls the call center 400 and states the purpose of the call 410 in his or her own words. The proposed speech-to-text algorithm converts this audio data to text 420 which includes recognized words and syllables of unrecognized words. A customer service representative then receives the text 430 and decides on the appropriate response 440: whether to receive the call 450, redirect it to a different person 460, generate an automatic predefined recorded response 470 or activate any other available option 480.

Similarly, this solution may be implemented in the telephone switchers of an organization or of a residence such as PBX or in the phone devices themselves. In such cases the calling party is requested to state the purpose of the call and the called party receives the textual transcription of the statement given by the calling party. The called party can then decide whether or not to answer the call at that point, redirect it, generate an automatic predefined recorded response or any other available options.

While the above description contains many specifications, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

What is claimed is:

1. A method for converting audible input into text, said method comprising the steps of:
i. applying speech-to-text recognition techniques for identifying words of received audible input;
ii. verifying identified words against vocabulary database of words;
iii. identifying syllable of unidentified audible input or utterances;
iv. creating a combined text of the recognized words appearing in the vocabulary database and the sequences of the identified syllables of the words not found in the vocabulary database.

2. The method of claim 1 wherein the audible input is originated by a first user for communicating with a second user further comprising the steps of:
i. relaying combined text to the second user;
ii. presenting the second user the combined text.

3. The method of claim 2 further comprising the step of: presenting the first user the combined text before relaying it to the second user.

4. The method of claim 2 further comprising the step of: enabling the first user to edit the combined text before relaying it to the second user.

5. The method of claim 1 wherein the creation of the syllables includes the steps of
i. identifying vowels of the analyzed word;
ii. identifying the consonants appearing before each vowel and associating them to said vowel;
iii. identifying the consonants appearing after each vowel which were not already associated with the next vowel and associating them with their preceding vowel;
iv. creating phonetic sequences of letters based on all identified syllables.

6. The method of claim 2 wherein the first and second users are communicating through a wireless communication network, further comprising the steps of: transferring the combined text from the mobile phone of the first user to the mobile phone of the second user through a wireless communication network.

7. The method of claim 2 wherein the first and second users are participants of a wireless communication session, further comprising the steps of: transferring the combined text from the mobile phone of the first user to the mobile phone of the second user through the open connection of the wireless communication session.

8. The method of claim 2 wherein the first and second users are communicating through a wired communication network, further comprising the steps of: transferring the combined text from the terminal of the first user to a terminal of the second user through the wired communication network.

9. The method of claim 1 wherein the audible input is originated by a user requesting service from a call center, wherein said call center includes a software application, further comprising the steps of: analyzing the combined message text in accordance with its context and performing a service action in accordance with said message analysis.

10. The method of claim 9 wherein the service action includes a predefined response to be sent to the user.

11. The method of claim 9 wherein the service action includes an identification of required service and selection of appropriate customer service representative to take care of the required service, wherein the customer service representative is provided with the combined text.

12. The method of claim 1 wherein the audible input is originated by a user requesting service from a call center, further comprising the step of relaying the combined message text to at least one customer service representative, wherein the customer service representative selects the appropriate action in accordance with the received combined text.

13. The method of claim 1 wherein the audible input is originated by a user requesting to create a communication session with a second user, further comprising the step of relaying the combined message text to at least one telephone switcher associated with said second user, wherein the second user is enabled to read the combined text and select the appropriate action.

14. The method of claim 2 further comprising the step of changing the text formats of said syllables of unidentified audible input or utterances within the combined text.

15. The method of claim 1 further comprising the step of filtering out unidentified audible input or utterances which are recognized as background noise.

16. The method of claim 1 wherein the combined text is saved as backup file for audio inputs.

17. The method of claim 1 wherein the combined text is utilized as a text for dictating purposes.
